(19) United States
(12) Patent Application Publication
(10) Pub. No.: US 2001/0037702 A1
(43) Pub. Date: Nov. 8, 2001

(54) DOOR HANDLE ASSEMBLY WITH FLUID DAMPED INERTIAL RESISTANCE

(75) Inventors: ROBERT W. MCFARLAND, ROCHESTER HILLS, MI (US); RICHARD T. YOUNG, LOWELL, MI (US)

Correspondence Address: DONALD L WOOD, YOUNG & BASILE, 3001 WEST BIG BEAVER ROAD, SUITE 624, TROY, MI, 48084

(73) Assignee: Donald L Wood

(21) Appl. No.: 09/253,364

(22) Filed: Feb. 22, 1999

(51) Int. Cl. F16F 9/00

(52) U.S. Cl. 74/573 F

(57) ABSTRACT

A door handle assembly for a motor vehicle which acts to preclude inadvertent unlatching of the door in response to a side impact. Several embodiments of the inventions are disclosed. Each embodiment includes a damper in the form of a vane/piston assembly positioned within a cylinder with fluid trapped between the vane assembly and the cylinder. In response to a side impact scenario generating inertial forces tending to inadvertently move the door handle in an unlatching direction, the vanes or piston coact with the cylinder and with the trapped fluid to resist such opening movement of the handle. In each of the several disclosed embodiments the axis of relative movement of the damper elements is incongruent with respect to the axis of movement of the handle whereby to address packaging problems that are peculiar to certain vehicle door environments.

### BACKGROUND OF THE INVENTION

This invention relates to handle assemblies for controlling the latch mechanisms on vehicle door assemblies and more particularly to such handle assemblies that include provision to preclude inadvertent opening of the latch mechanism in response to a side impact.

Vehicle doors typically include a latch mechanism for latching and unlatching the door to the vehicle body, a handle assembly positioned on the door and operative to control the latch mechanism, and a lock mechanism to selectively render the handle assembly effective or ineffective to operate the latch. It is imperative that side impact against the vehicle, resulting for example from a collision, not result in the inadvertent movement of the handle of the handle assembly to a latch release position with consequent movement of the latch to an unlatched position and consequent inadvertent opening of the door. This in general is not a problem when the door is locked since in this case the door handle is either precluded from movement by the lock mechanism or the door handle is allowed to freewheel to its unlatched position but this movement is ineffective to move the latch to its unlatched position.

However, when the door is unlocked, as is most typically the case in an operating vehicle, side impact can easily result in inertial movement of the door handle to its unlatched position with consequent unlatching of the latch mechanism, consequent opening of the door, and consequent discharge of unbuckled vehicle passengers from the vehicle.

Various attempts have heretofore been made to address the side impact problem and specifically to avoid inadvertent opening of the vehicle door in a side impact situation. In a commonly employed arrangement, a heavy duty spring is employed in association with the door handle. This spring may be sized, for example, to preclude movement of the door handle to its open position in crash situations involving up to 30 Gs of impact force. Whereas this arrangement satisfies the existing Federal Motor Vehicle Safety standards with respect to side impact, it also results in a door handle that is very difficult to open because of the heavy duty spring employed in association with the door handle. Other attempts to address the side impact problem have employed mechanisms that block movement of the door handle to a door unlatching position in response to a side impact but these blocking mechanisms have been complicated and expensive. A further arrangement addressing the side impact problem is shown in U.S. Pat. No. 5,743,573, assigned to the assignee of the present invention, in which a fluid damping arrangement is provided to resist inadvertent opening of the door in a side impact situation. Although the fluid damped arrangement of U.S. Pat. No. 5,743,573 is generally satisfactory and effective, the peculiar package geometry of the door latch actuator of U.S. Pat. No. 5,743,575, wherein the damper axis is coincident with the axis of pivotal movement of the door handle, is incompatible with the packaging requirements of certain automotive door handle environments.

### SUMMARY OF THE INVENTION

This invention is directed to the provision of an improved door handle assembly for use with a motor vehicle.

More specifically, this invention is directed to the provision of a motor vehicle door handle assembly that operates to resist inadvertent opening of the door in the event of a side impact against the vehicle.

Yet more specifically, this invention is directed to the provision of a motor vehicle door handle assembly that operates to preclude inadvertent opening of the door in the event of a side impact against the vehicle and that presents a package geometry that is especially suitable for use in many automotive door handle environments.

The motor vehicle door handle assembly of the invention is intended for use in actuating a door latch of the vehicle to allow opening and closing of the vehicle door and includes a handle mounted for movement along or about a handle movement axis between an unlatched position in which the door latch is unlatched and a rest position. According to the invention, the actuator further includes first and second damper elements mounted for relative movement along or about a damper element movement axis that is incongruent with respect to the handle movement axis; means are provide for trapping a quantity of fluid between the first and second damper element; and drive means are provided which are operative to move the first damper element relative to the second damper element along or about the damper element movement axis against the resistance of the trapped fluid during at least the initial portion of the opening movement of the door handle from the rest position to the unlatched position. This arrangement provides a simple and effective structure for precluding inadvertent opening movement of the door handle in a side impact situation.

According to a further feature of the invention, the drive means are operative to move the first damper element relative to the second damper element along or about the damper element movement axis against the resistance of the trapped fluid during the entire range of the opening movement of the door handle from the rest position to the unlatched position and during the entire range of the return movement of the door handle from the unlatched position to the rest position. This arrangement cushions the entire movement of the door handle in both opening and closing directions to provide a velvety feel for the door handle operation and further provides an effective means of resisting inadvertent opening movement of the door handle in a side impact situation.

### BRIEF DESCRIPTION OF THE DRAWINGS

FIG. 1 is a fragmentary perspective view of a motor vehicle including a door embodying the door handle assembly of the invention;

FIG. 2 is a fragmentary perspective view of the invention door handle assembly;

FIGS. 3 and 4 are cross-sectional views taken respectively on lines 3-3 and 4-4 of FIG. 2;

FIG. 5 is a cross-sectional view taken on line 5-5 of FIG. 3;

FIG. 6 is a perspective, fragmentary, somewhat schematic view of the invention door handle assembly incorporated in a vehicle door assembly;

FIGS. 7 and 8 are somewhat schematic views of a second embodiment of the invention door handle assembly;

FIGS. 9 and 10 are somewhat schematic views of a third embodiment of the invention door handle assembly;

FIGS. 11 and 12 are somewhat schematic views of a fourth embodiment of the invention door handle assembly;

FIG. 13 is a somewhat schematic view of a fifth embodiment of the invention door handle assembly; and

FIG. 14 is a somewhat schematic view of a sixth embodiment of the invention door handle assembly.

### DETAILED DESCRIPTION OF THE PREFERRED EMBODIMENT

The invention door handle assembly 10 is seen in FIG. 1 in association with a fragmentarily shown motor vehicle 12 including a windshield 14, a front quarter panel 16, a hood 18, an A-pillar 20, a sill 22, a B-pillar 24, and a door 26 positioned in the door opening defined by A-pillar 20, front quarter panel 16, sill 22, and B-pillar 24.

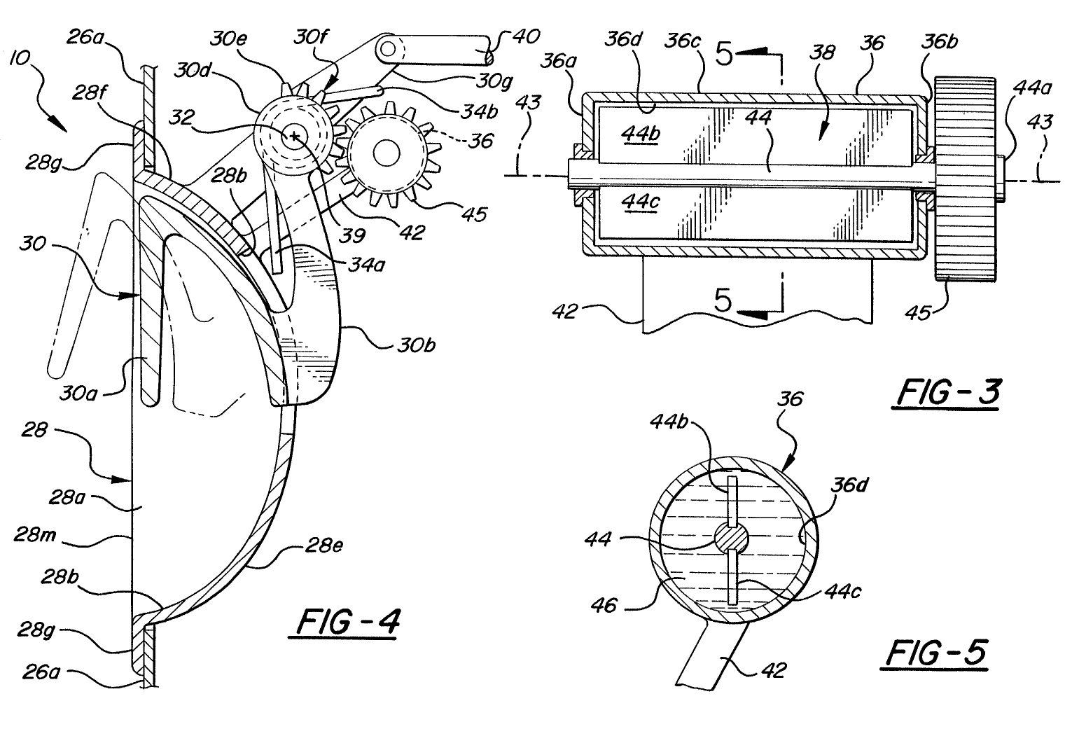

Door handle assembly 10 (FIGS. 1-5) includes a housing or bezel 28, a handle member 30, a pivot shaft 32, a coil spring 34, a damper cylinder 36, and a vane assembly 38.

Bezel or housing 28 includes a main body bowl portion 28a defining laterally spaced rectangular slots 28b, and a pair of laterally spaced lug portions 28c, 28d extending outwardly and rearwardly from the bowl portion. Lug portion 28c is positioned immediately outboard of one slot 28b and lug portion 28d is positioned immediately outboard of the other slot 28b. Bowl portion 28a has a U or V-shaped configuration in cross-section and includes a lower arcuate section 28e and an upper arcuate section 28f. Slots 28b are provided in laterally spaced relation in upper bowl portion 28f and lug portions 28c, 28d extend outwardly and upwardly from upper bowl portion 28f in proximity to respective slots 28b.

Handle member 30 includes a handle portion 30a of inverted V-shaped cross-sectional configuration positioned in housing bowl portion 28a, and laterally spaced crank arm portions 30b, 30c extending outwardly and upwardly from handle portion 30a and passing through respective slots 28b in the housing bowl portion.

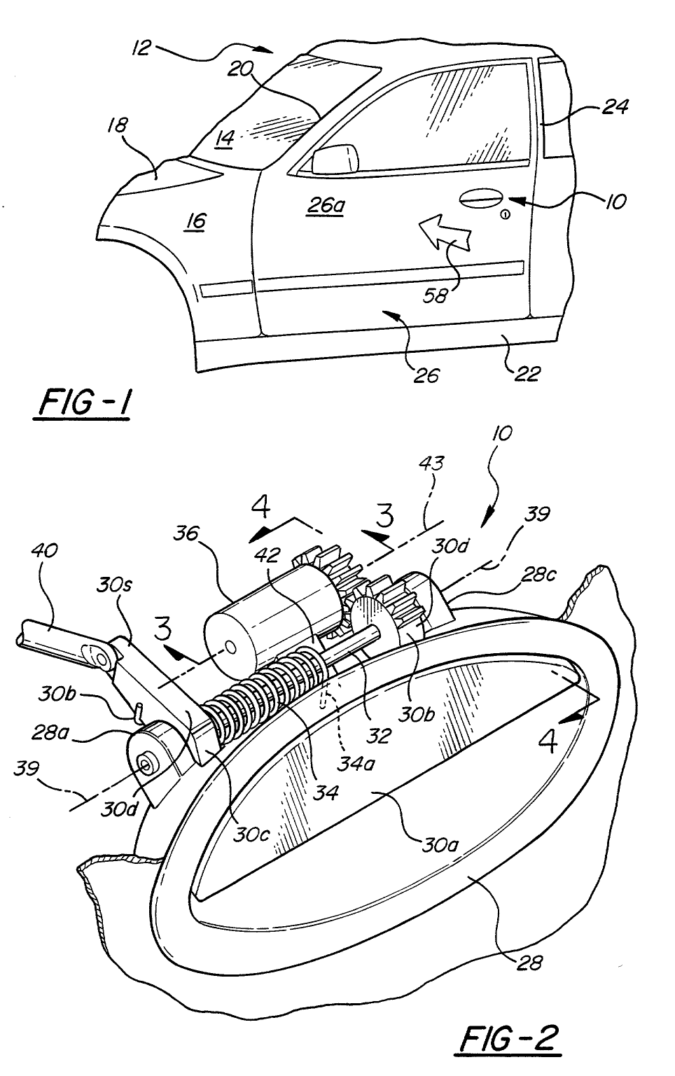

Pivot shaft 32 extends between the upper ends of housing lug portions 28c, 28d and mounts the upper ends 30d of lugs 30b, 30c whereby to mount the handle member for pivotal movement about the axis 39 defined by pivot shaft 32 between the solid line rest or latched position seen in FIGS. 2 and 4 and the dash line open or unlatched position seen in FIG. 2. Crank arm portion 30c includes a tail or actuator portion 30g for attachment to a control link 40 to actuate the latch of the vehicle door in known manner in response to pivotal movement of the handle member. A plurality of circumferentially spaced teeth 30e are provided on the upper end 30d of handle lug portion 30b to form a gear segment 30f centered on axis 39.

Coil spring 34 is positioned around pivot shaft 32 and includes an end 34a bearing against the rear face of bowl upper portion 28f and an opposite end 34b hooked around crank arm tail portion 30g. Spring 34 will be seen to resiliently resist opening movement of the handle (in a clockwise direction about the axis 39 of pivot shaft 32 as seen in FIG. 4) and to normally maintain the handle member in the solid line rest or latched position of FIG. 4 in which the handle portion of the handle member is seated firmly within the bowl portion of the bezel housing.

Damper cylinder 36 is positioned rearwardly of and in proximity to the upper end 30d of crank arm portion 30b by an arm or spoke 42 extending upwardly and rearwardly from bezel upper bowl portion 28f. The central cylindrical axis 43 of cylinder 36 is positioned parallel to but in rearwardly spaced relation with respect to the axis 39 of shaft 32. Cylinder 36 includes end walls 36a and 36b and a cylindrical side wall 36c coacting to define a cylindrical inner chamber 36d.

Vane assembly 38 includes a central shaft 44 journaled in cylinder end walls 36a, 36b for rotation about the central axis 43 of the cylinder, a sprocket 45 fixedly secured to end 44a of shaft 44 outboard of cylinder end wall 36b meshingly engaging with gear segment 30f, and diametrically opposed vanes 44b, 44c positioned within cylinder chamber 36d. Cylinder chamber 36d is filled with a temperature stable viscous silicone fluid 46. Rotation of vanes 44b, 44c within cylinder chamber 36 will be seen to generate a viscous damping action with the strength of the damping action being a function of several factors including viscosity of the fluid and the radial and axial spacing between the vanes and the respective inner surfaces of cylinder cavity 36d. The damping action may accordingly be readily and selectively varied to accommodate a wide variety of vehicle door assemblies.

In the assembled relation of the door handle assembly, handle portion 30a of the handle member is positioned within the bowl portion 28a of the bezel housing; the crank arms of the handle member extend upwardly and outwardly through slots 28b in respective juxtaposition to inboard faces of lug portions 28c, 28d; the upper free ends 30d of the crank arms are mounted on pivot shaft 32 to mount the handle member for pivotal movement about the axis 39 of shaft 32 between latching and unlatching positions; spring 34 acts to urge the handle member to its latched position seen in FIG. 4 while allowing spring resistant pivotal movement of the handle in a clockwise direction as seen in FIG. 4 to unlatch the associated door latch mechanism; and gear segment 30f is positioned in meshing engagement with sprocket 45.

As seen in FIG. 4, handle assembly 10 is positioned in the outer skin 26a of door 26 by suitably securing the peripheral flange 28g of the bezel to the outer skin to position the bezel cavity 28l rearwardly of the outer skin and within the door and position the bezel window 28m generally flush with the door outer skin.

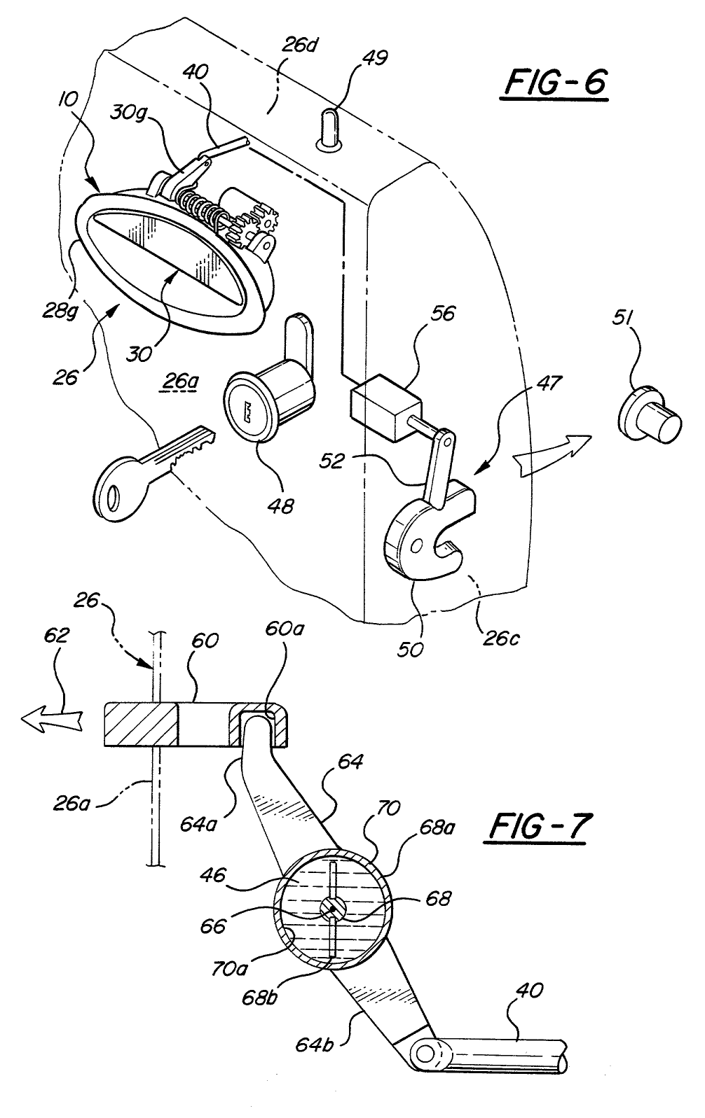

As seen in FIG. 6, handle assembly 10 is intended for use with a vehicle door assembly including door 26, a latch assembly 47 positioned on the shut face 26c of the door, a key cylinder lock 48 positioned in the outer skin 26a of the door proximate door handle assembly 10, and a push button lock 49 positioned on the top sill 26d of door 26 in overlying relation to latch assembly 47 and coupled for joint operation with key cylinder lock 48. Latch assembly 47 is of known form and includes a latch member 50 coacting with a bolt 51 on the confronting face of the vehicular structure to pivotally move the latch member 50 between latched and unlatched positions. Latch assembly 47 further includes a dog 52 coacting with a detent on latch member 50 to maintain the latch member in its latched condition against the bias of a spring (not shown) and operative when released to allow the latch member to return under the bias of the spring to the unlatched position and thereby move the door to an unlatched position. Dog 52 is controlled in known manner by control link 40 whereby pivotal movement of crank arm 30c with key cylinder 48 and push button 49 in an unlocked condition has the effect of releasing the latch member 50 for movement to an unlatched position. However, latch assembly 47 in known manner further includes a decoupling mechanism 56 (shown schematically) which serves to render control link 40 ineffective to release the latch member 50 when the push button 49 and lock cylinder 48 are in a locked condition.

In the operation of the invention door handle assembly, door handle 30 is normally free to move between latched and unlatched positions to latch and unlatch the door assembly 47 as desired. Opening movement of the handle is resisted by spring 34 and gear segment 30f coacts with sprocket 45 during opening and closing movement of the door handle to move vanes 44b, 44c within cylinder chamber 36c against the resistance of viscous fluid 46 to provide a continuous damping effect for both the opening and closing movement of the handle. As the handle is released for return movement following movement of the handle to an unlatched position, the damper elements cushion the movement of the handle member to its rest position to provide a perception of quality and to reduce noise in the operation of the handle. More importantly, in the event of a side impact against the vehicle as schematically represented by the arrow 58 in FIG. 1, inadvertent inertial opening movement of the handle in response to the side impact is resisted by the viscous interaction of the cylinder and vane assembly. The extent to which the damper elements coact to resist inadvertent opening movement of the handle member in a side impact scenario may be selectable varied by varying the specifications of the viscous fluid 46 filling the chamber 36d, varying the radial and axial clearances between the vanes 44b, 44c and the confronting inner surfaces of the cylinder, and generally varying the size and other parameters of the damping elements.

Pivotal movement of the handle from its latched to its unlatched position will of course have no effect on the latching member 50 if the lock mechanism 48/49 is in a locked condition since in this situation the decoupler 56 will act to decouple any movement of the control link 40 from the dog 52 and result in the handle simply freewheeling with no consequent unlatching of the door. However, the most typical operating mode of a moving vehicle involves unlocked doors and, in this most common scenario, side impact, if not guarded against in a manner such as in accordance with the present invention, can readily result in inertial movement of the handle to an unlatched position with consequent unlatching of the door. As noted, however, this inadvertent unlatching movement of the handle and consequent unlatching of the door is effectively resisted in the door handle assembly of the present invention by the viscous coaction of the damping elements.

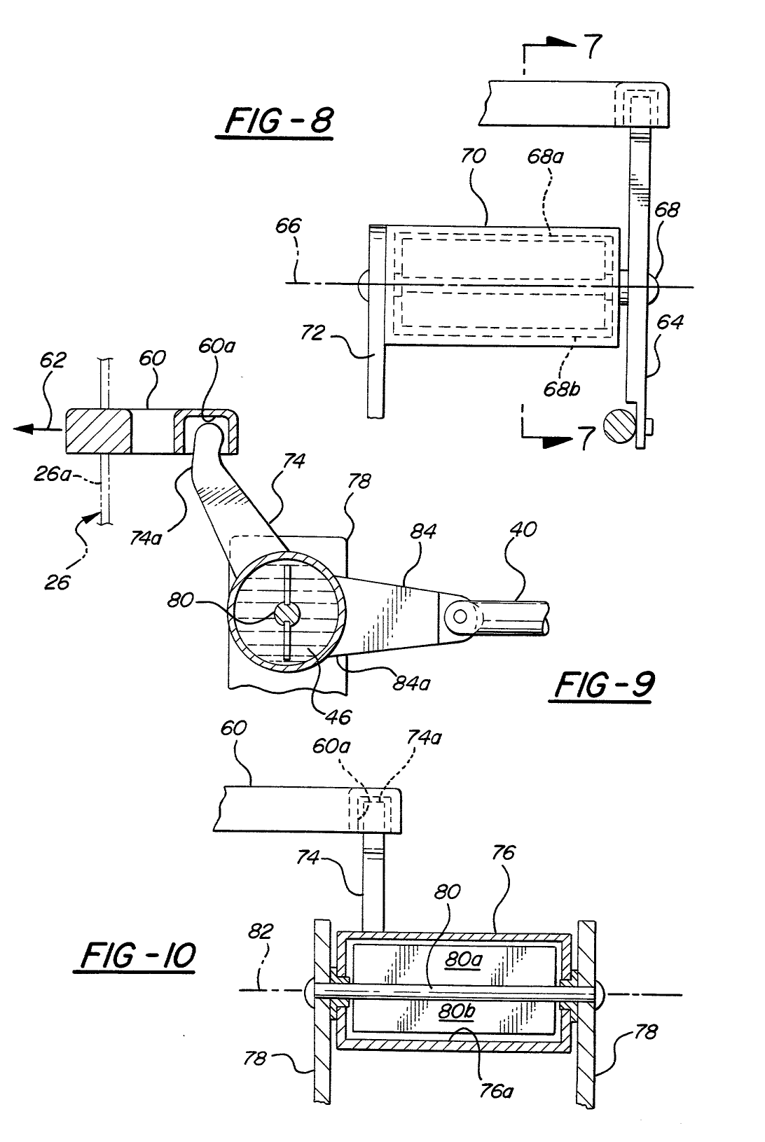

In the modified door latch actuator embodiment seen in FIGS. 7 and 8, a suitcase type door handle 60 mounted for opening and closing movement in door 26 along an axis 62 includes a pocket 62a receiving the upper end 64a of a lever crank arm 64 mounted for pivotal movement about an axis of rotation 66 and including a lower end 64b connected to control link 40. A shaft 68 is fixedly secured to arm 64 coincident with axis 66 and extends into a cylinder 70 fixedly secured to the associated door structure as for example by a bracket 72. Diametrically opposed vanes 68a, 68b are fixedly positioned on shaft 68 within the cavity 70a of cylinder 70 and a viscous silicone fluid 46 fills the cavity. In operation, as the handle 60 is moved outwardly and inwardly along axis 62 to actuate the latch mechanism, crank arm 64 is rotated about axis 66 with the result that vanes 66a, 68b rotate with respect to fixed cylinder 70 to provide a viscous damping action with respect to movement of the handle in both directions along axis 62.

In the event of a side impact scenario in which handle 60 attempts to move outwardly or to the left as seen in FIG. 7 under the inertia forces of the side impact, vanes 68a, 68b coact with the confronting inner surfaces of cylinder cavity 70a to provide a viscous cushioning resistance to outward movement of the handle to thereby resist opening of the latch mechanism and inadvertent opening of the vehicle door.

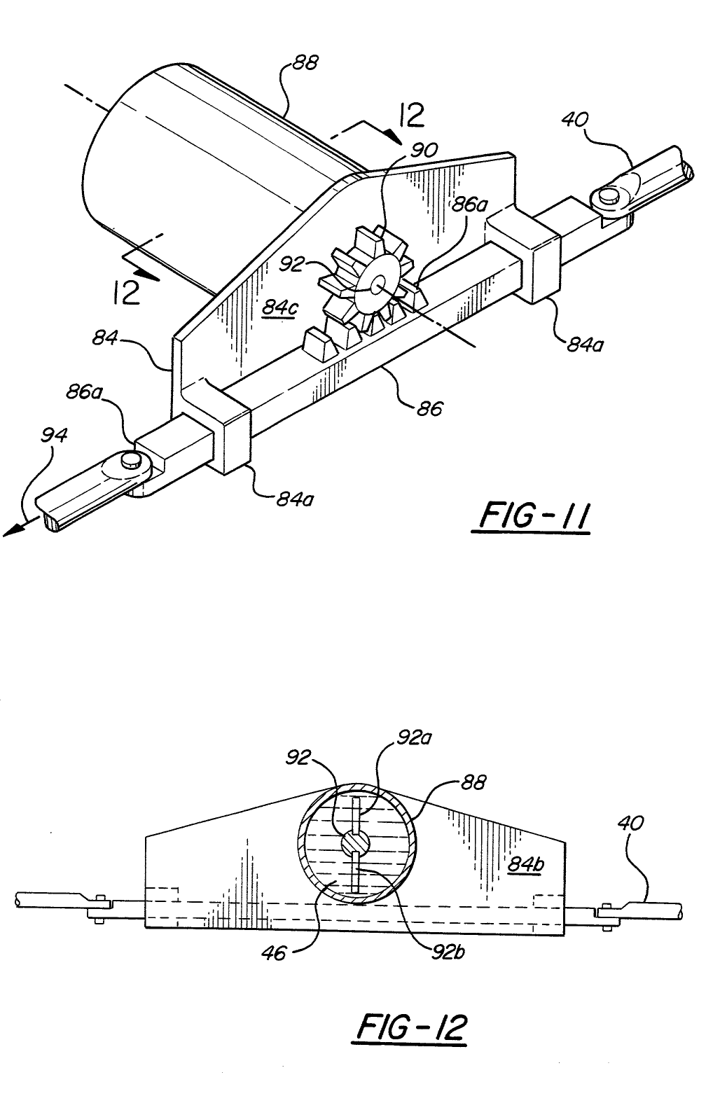

In the door latch actuator embodiment seen in FIGS. 9 and 10, a suitcase type handle 60 moves along axis 62 and handle pocket 60a coacts with the upper end 74a of a crank arm 74. The lower end 74b of the crank arm is fixedly secured to a cylinder 76 which is filled with viscous fluid 46 and which is mounted for rotation between brackets 78 fixedly secured to the associated door structure. Rotational movement of the cylinder is defined by a pivot shaft 80 extending fixedly between the brackets 78 and defining a pivot axis 82. Fixed diametrically opposed vanes 80a, 80b coact with inner surfaces of the inner chamber 76a of cylinder 76 to provide a viscous resistance to relative rotation of the cylinder and the vanes. A further crank arm 84 is fixedly secured at one end 84a to cylinder 76 and is coupled at its other, outboard end to control link 40. Vanes 80a, 80b coact with cylinder 76 in viscous fashion to damp the opening and closing movements of the handle assembly and specifically coact in the event of a side impact scenario to resist opening movement of the door handle under the inertial side impact loading to thereby resist inadvertent unlatching of the door.

In the door latch actuator embodiment of FIGS. 11 and 12, a bracket 84 fixedly secured to the associated door structure defines guide structures 84a slideably mounting a rack 86 including rack teeth 86a. A cylinder 88 is fixedly secured to the rear face 84b of the bracket and a pinion 90 is mounted on the front face 84c of the bracket with the central shaft 92 of the pinion extending through bracket 84 and into the hollow interior of cylinder 88 where diametrically opposed vanes 92a, 92b coact with the inner surface of cylinder 88 and with silicone fluid 46 trapped within the cylinder to provide a viscous damping action. One end 86a of rack 86 is suitably secured to the handle of the door latch actuator and the other end 86b of the rack is secured to control link 40. In operation, movement of rack 86 along axis 94 in response to suitable actuation of the door handle rotates pinion 90 by virtue of its meshing coaction with rack teeth 86a whereby to rotate vanes 92a, 92b within the chamber of cylinder 88 to create a viscous damping action with respect to movement of the rack 86 in either direction. In response to a side impact scenario, viscous coaction between vanes 92a, 92b and cylinder 88 has the effect of resisting inadvertent opening movement of the latch in the manner previously described.

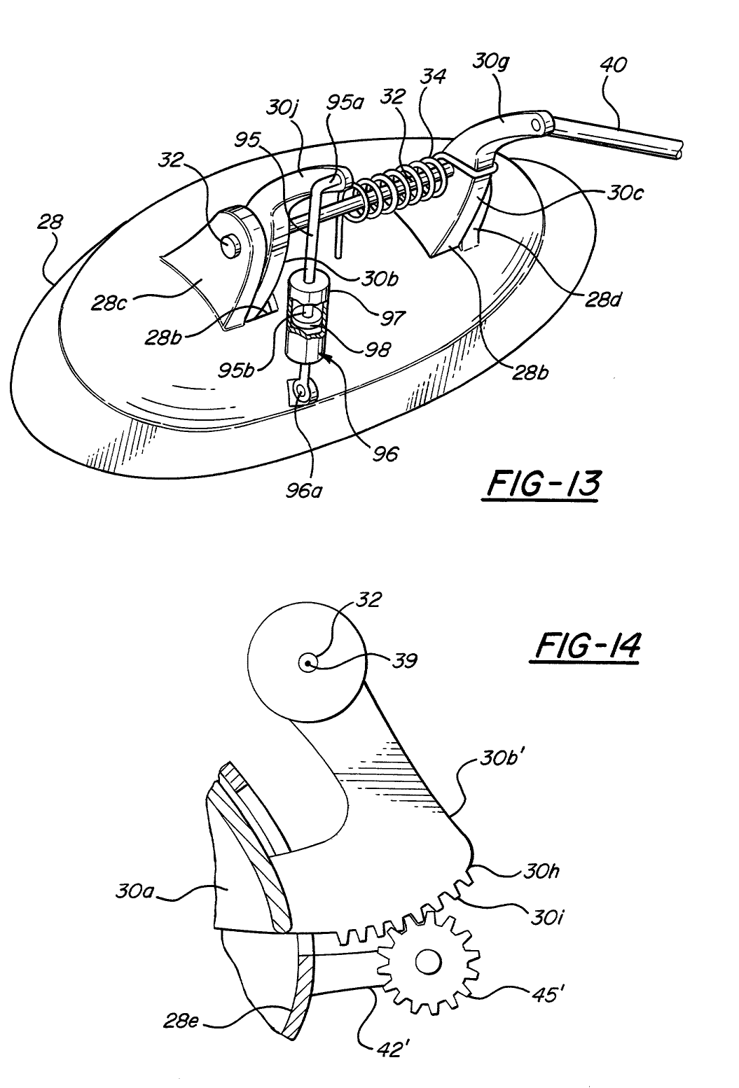

In the door latch actuator emobodient of FIG. 13, crank arm portion 30b includes a tail or actuator portion 30j generally similar to the tail or actuator portion 30g forming an extension of crank arm portion 30c, and a piston rod 95 forming a part of an air damper 96 is connected pivotally at its upper end 95a to the free or outer end of tail 30j and extends at its lower end 95b into the interior or the cylinder 97 of the air damper for connection to a piston 98. The lower end 96a of cylinder 96 is suitably pivotally secured to bezel 28. Suitable valving is provided in the air damper to allow selective flow of air past the piston 98 and thereby selectively resist the opening and closing of the handle, whereby to resist inadvertent unlatching of the vehicle door latch in the event of side impact and provide a cushioning action with respect to the opening and closing movement of the door handle.

The door latch actuator embodiment of FIG. 14 is generally similar to the FIGS. 1-6 embodiment with the exception that the crank arm portion 30b′ of handle member 30 is modified to provide an arcuate surface 30h centered on pivot axis 39 and a plurality of circumferentially spaced teeth 30i are provided on arcuate surface 30h for driving engagement with a sprocket 45′ supported on bezel 28 by an arm or spoke 42′. It will be understood that teeth 30i coact with sprocket 35′ during opening and closing movement of the door handle to move vanes 44b, 44c within cylinder chamber 36c against the resistance of viscous fluid 46 to provide a continuous damping effect for both the opening and closing movement of the handle. Removal of the teeth from the upper end of the handle arm portion, placement of teeth along an arcuate surface of the arm portion, and movement of the driven sprocket to a location generally beneath the teeth on the arm portion, provides packaging and mechanical advantages with respect to certain door installations.

Each of the door handle embodiments will be seen to provide an effective means of resisting inadvertent unlatching of the vehicle door latch mechanism in the event of side impact while yet allowing the ready operation of the door handle assembly under normal operating conditions. Further, the invention door handle assemblies are simple in construction and operation and adapt readily to a wide variety of door configurations and door packaging requirements. Specifically, incongruent positioning of the damper element movement axis with respect to the handle movement axis allows the door latch actuators of the invention to be utilized in automotive door scenarios where a congruent relationship between the damper element axis and the handle movement axis would preclude or extremely complicate installation of the latch mechanism in the door.

Whereas preferred embodiments of the invention have been illustrated and described in detail it will be apparent that various changes may be made in the disclosed embodiments without departing from the scope or spirit of the invention.

I claim:

1. A fluid damped automotive door latch actuator comprising:
a handle mounted for movement along or about a handle movement axis between an unlatched position in which the door latch is unlatched and a rest position;
first and second damper elements mounted for relative movement along or about a damper element movement axis that is incongruent with respect to the handle movement axis;
means for trapping a quantity of fluid between said first and second damper elements; and
drive means operative to move the first damper element relative to the second damper element along or about said damper element movement axis against the resistance of the trapped fluid during at least the initial portion of the opening movement of the door handle from the rest position to the unlatched position.

2. A fluid damped automotive door latch actuator according to claim 1 wherein the drive means is operative to move the first damper element relative to the second damper element along or about said damper element movement axis against the resistance of the trapped fluid during the entire range of the opening movement of the door handle from the rest position to the unlatched position.

3. A fluid damped automotive door latch actuator according to claim 2 wherein the drive means is further operative to move the first damper element relative to the second damper element along or about said damper element axis against the resistance of the trapped fluid during the entire range of the return movement of the door handle from the unlatched position to the rest position.

4. A fluid damped automotive door latch actuator according to claim 3 wherein the actuator further includes bias means operative in response to opening movement of the handle to urge the handle toward the rest position.

5. A fluid damped automotive door latch actuator comprising:
a handle mounted for opening movement along or about a handle movement axis from a rest position to an unlatched position in which the door latch is unlatched and return movement from the unlatched position to the rest position;
bias means operative in response to opening movement of the handle to urge the handle toward the rest position;
first and second damper elements mounted for relative movement along or about a damper element movement axis that is incongruent with respect to the handle movement axis;
means for trapping a quantity of fluid between said first and second damper elements; and
drive means operative to move the first damper element relative to the second damper element along or about said damper element movement axis against the resistance of the trapped fluid during the entire range of the opening movement of the door handle from the rest position to the unlatched position and during the entire range of the return movement of the door handle from the unlatched position to the rest position.

6. A fluid damped automotive door latch actuator according to claim 5 wherein;
one of the damper elements comprises a cylinder having a central cylinder axis defining the damper element movement axis;
the other damper element comprises a vane positioned in the cylinder; and
the vane and cylinder are relatively rotatable about an axis of rotation coincident with the central axis of the cylinder.

7. A fluid damped automotive door latch actuator according to claim 6 wherein the vane comprises said first damper element.

8. A fluid damped automotive door latch actuator according to claim 6 wherein;
the handle movement axis comprises an axis of rotation parallel to and spaced from the axis of rotation of the vane and cylinder; and
the drive means includes first and second meshing drive elements positioned respectively on the handle axis of rotation and the vane and cylinder axis of rotation.

9. A fluid damped automotive door latch actuator according to claim 8 wherein the vane is driven by the second meshing drive element and mounted for rotation in the cylinder about the vane and cylinder axis of rotation.

10. A fluid damped automotive door latch actuator according to claim 6 wherein;
the drive means comprises an arm drivingly engaging the handle at one end thereof and drivingly engaging one of said cylinder and vane at another end thereof.

11. A fluid damped automotive door latch actuator according to claim 10 wherein said other end of said arm drivingly engages said vane.

12. A fluid damped automotive door latch actuator according to claim 10 wherein said other end of said arm drivingly engages said cylinder.

13. A fluid damped automotive door latch actuator according to claim 6 wherein the drive means comprises a rack drivingly connected to the handle and a pinion driven by the rack and driving one of the damper elements.

14. A fluid damped automotive door latch actuator according to claim 13 wherein the pinion drives the vane.

15. A fluid damped automotive door latch actuator according to claim 5 wherein:
one of the damper elements comprises a cylinder having a central cylindrical axis defining the damper element movement axis;
the other damper element comprises a piston slidably positioned in the cylinder; and
the drive means comprises a piston rod connected at one end thereof to the piston and connected at another end thereof to the handle.
